(19) United States
(12) Patent Application Publication
(10) Pub. No.: US 2015/0116486 A1
(43) Pub. Date: Apr. 30, 2015

(54) TERMINAL DEVICE, IMAGE MEASURING SYSTEM AND METHOD OF INSPECTION OF WORKPIECE

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); ZHONG-KUI YUAN, Shenzhen (CN); XIAO-GUANG XUE, Shenzhen (CN); JUN-HUA LI, Shenzhen (CN)

(21) Appl. No.: 14/521,723

(22) Filed: Oct. 23, 2014

(30) Foreign Application Priority Data
Oct. 29, 2013 (CN) 201310519056.3

(51) Int. Cl. G01B 11/02; H04N 5/372; G01B 11/14

(52) U.S. Cl. CPC G01B 11/022; G01B 11/14; H04N 5/372
USPC 348/140

(57) ABSTRACT

An image measuring system includes an interface module, an automatic measuring module, and an outputting module. The interface module is configured to display an image of a workpiece. The automatic measuring module finds features on the image of the workpiece, constructs a coordinate system according to the searched features, and measures a distance from each point on the workpiece to the constructed coordinate system. The outputting module compares the distance with a predetermined tolerance range and outputs the distance and a compared result to the interface module.

### CROSS-REFERENCE TO RELATED APPLICATIONS

This application claims priority to Chinese Patent Application No. 201310519056.3 filed on Oct. 29, 2013, the contents of which are incorporated by reference herein.

### FIELD

The disclosure generally relates to a terminal device, an image measuring system and a method of inspection of a workpiece.

### BACKGROUND

Commonly, a workpiece needs to be measured before mass produced, so as to inspect a quality of the workpiece, for example, whether a shape and a size of the workpiece are in a predetermined tolerance range. With a development of information technology, computers are now used for the measurement of the workpiece before mass produced for improving efficiency and an accuracy of the measurement.

### BRIEF DESCRIPTION OF THE DRAWINGS

Implementations of the present technology will now be described, by way of example only, with reference to the attached figures.

FIG. 1 is a block diagram of an embodiment of a terminal device including an image measuring system and electronically connected to an image measuring machine.

FIG. 2 is a block diagram of the image measuring system of FIG. 1.

FIG. 3 is a flowchart of an embodiment of a method of inspection of a workpiece.

FIG. 4 is a detailed description of block 309 in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives. The term “comprising” when utilized, means “including, but not necessarily limited to”; it specifically indicates open-ended inclusion or membership in the so-described combination, group, series and the like.

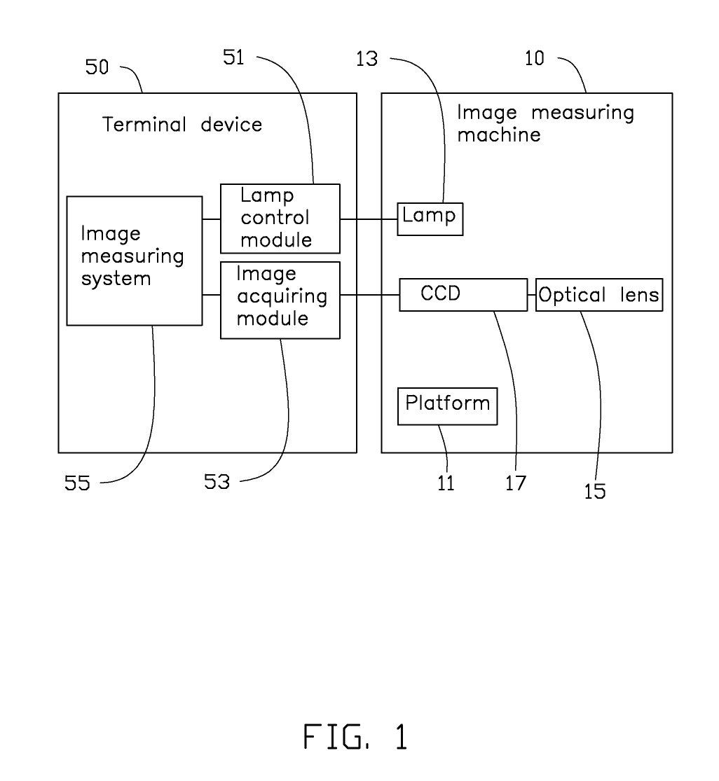

FIG. 1 illustrates an embodiment of a terminal device 50 electronically connected to an image measuring machine 10. In one embodiment, the terminal device 50 may be a computer, a server, or other processing device. The image measuring machine 10 includes a platform 11, a lamp 13, an optical lens 15, and a charge coupled device (CCD) 17.

The platform 11 is configured for placing a workpiece. The lamp 13 is positioned on the platform 11 and is configured to provide different kinds of light, such as, ring light, outline light, and coaxial light, to help the optical lens 15 to shoot the workpiece from different angles. The CCD 17 is electronically connected to the optical lens 15. The CCD 17 captures an image of the workpiece that is focused by the optical lens 15 and transmits the captured image to the terminal device 50.

As illustrated, the terminal device 50 includes a lamp control module 51, an image acquiring module 53, and an image measuring system 55. The lamp control module 51 is electronically connected to the lamp 13. The lamp control module 51 is configured for controlling the lamp 13 to turn on or off and for adjusting a luminance of the lamp 13. The image acquiring module 53 is electronically connected to the CCD 17 and is configured to receive the image captured by the CCD 17. The image measuring system 55 is electronically connected to the lamp control module 51 and the image acquiring module 53. In this embodiment, the image measuring system 55 receives the image from the image acquiring module 53 and measures whether a size of the workpiece is in a predetermined tolerance range according to the received image, so as to inspect a quality of the workpiece.

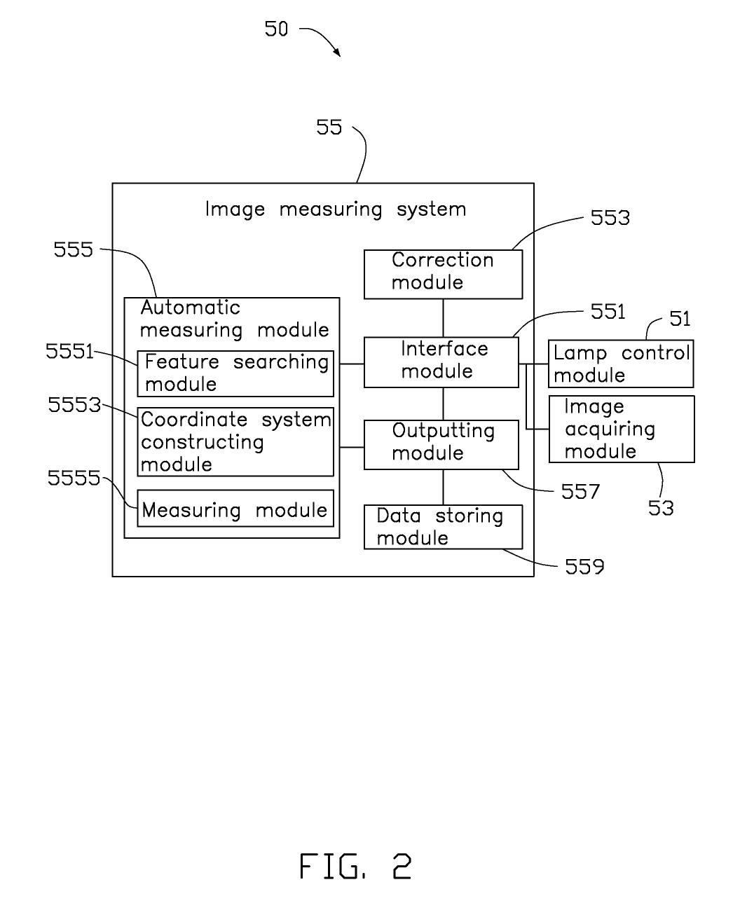

As illustrated in FIG. 2, the image measuring system 55 includes an interface module 551, a correction module 553, an automatic measuring module 555, an outputting module 557, and a data storing module 559.

In one embodiment, the interface module 551 may be a touch panel. The interface module 551 is electronically connected to the lamp control module 51. The interface module 551 is configured to adjust the luminance of the lamp 13 via the lamp control unit 51 according to control commands from an operator. The interface module 551 is also electronically connected to the image acquiring module 53 and is configured to display the image of the workpiece from the image acquiring module 53.

The correction module 553 is electronically connected to the interface module 551. Due to some factors, for example, a deviation caused by the CCD 17, the image of the workpiece may be distorted. Thus, to make the image captured by the CCD 17 satisfy a predetermined standard, the correction module 553 cooperates with the interface module 551 to rectify a precision of the CCD 17 when the CCD 17 is used in a first time. In this embodiment, the correction module 553 has a shape correction function and a length correction function. In detail, when the shape correction function is implemented, a shape calibration film is positioned below the optical lens 15, and a shape correction button on the interface module 551 is operated, then the correction module 553 adjusts the CCD 17 to ensure that the shape of the image from the CCD 117 satisfies the predetermined standard. When the length correction function is implemented, a length calibration film is positioned below the optical lens 15, and a length correction button on the interface module 551 is operated, then the correction module 553 adjusts the CCD 17 to ensure that the length of the image from the CCD 117 satisfies the predetermined standard. After the shape correction function and the length correction function are both implemented, the correction of the CCD 17 is finished.

The automatic measuring module 555 is electronically connected to the interface module 551. The automatic measuring module 555 is configured to construct a coordinate system and measure distance data of each point on the workpiece. The automatic measuring module 555 includes a feature searching module 5551, a coordinate system constructing module 5553, and a measuring module 5555.

The feature searching module 5551 is configured to find two features on the image of the workpiece displayed on the interface module 551. In this embodiment, the feature is a circle. The coordinate system constructing module 5553 is configured to construct a coordinate system according to the two circles searched by the feature searching module 5551. In this embodiment, the coordinate system takes a connecting line between the centers of the two circles as an X-axis, takes a midpoint of the connecting line as an origin, and constructs a Y-axis according to the constructed X-axis and the origin. The measuring module 5555 measure a distance from each point on the workpiece to the constructed X-axis and Y-axis. In this embodiment, the measuring module 5555 converts a position of each point on the workpiece to a coordinate value of the constructed coordinate system, then measures a distance from each point on the workpiece to the X-axis and Y-axis.

The outputting module 557 is electronically connected to the measuring module 5555. The outputting module 557 compares the distance data (that is, the distances from each point on the workpiece to the X-axis and Y-axis) with the predetermined tolerance range to determine whether the distance data is out of the predetermined tolerance range. The outputting module 557 is also electronically connected to the interface module 551 and is configured to transmit the distance data and the compared results to the interface module 551 for displaying dynamically. In this embodiment, different compared results can be identified by different colors. For example, when the distance from the point on the workpiece to the X-axis and Y-axis is in the predetermined tolerance range, a green label “OK” can be displayed on the interface module 551. When the distance from the point on the workpiece to the X-axis and Y-axis is out of the predetermined tolerance range, a red label “NG” can be displayed on the interface module 551.

The data storing module 559 is electronically connected to the outputting module 557. The data storing module 559 is configured to store all kinds of data produced in the process of measurement, for example, the predetermined tolerance range, the distance data, and the compared results.

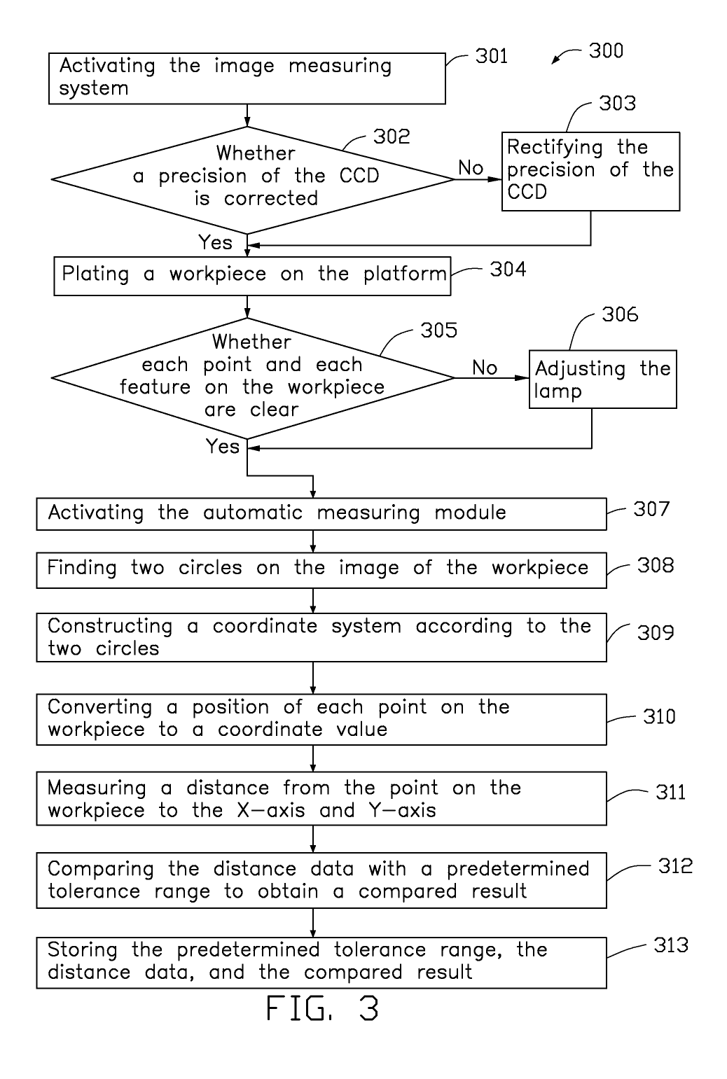

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301.

At block 301, the imaging measuring machine and the terminal device are both actuated to activate the image measuring system.

At block 302, the correction module detects that whether a precision of the CCD is corrected.

At block 303, the correction module rectifies the precision of the CCD when the correction module determines that the precision of the CCD is not corrected. In detail, when the shape correction function is implemented, a shape calibration film is positioned below the optical lens, and a shape correction button on the interface module is operated, then the correction module adjusts the CCD to ensure that the shape of the image from the CCD satisfies the predetermined standard. When the length correction function is implemented, a length calibration film is positioned below the optical lens, and a length correction button on the interface module is operated, then the correction module adjusts the CCD to ensure that the length of the image from the CCD satisfies the predetermined standard. After the shape correction function and the length correction function are both implemented, the correction of the CCD is finished.

At block 304, a workpiece is plated on the platform when the correction module determines that the precision of the CCD is corrected.

At block 305, the workpiece is determined that whether each point and each feature on the workpiece are clear.

At block 306, the lamp is adjusted when each point and each feature on the workpiece is not clear.

At block 307, the interface module is actuated to activate the automatic measuring module when each point and each feature on the workpiece is clear.

At block 308, the feature searching module finds two features on the image of the workpiece displayed on the interface module. In this embodiment, the feature is a circle.

At block 309, the coordinate system constructing module constructs a coordinate system according to the two circles searched by the feature searching module.

At block 310, the measuring module converts a position of each point on the workpiece to a coordinate value of the constructed coordinate system.

At block 311, the measuring module measures a distance from the point on the workpiece to the X-axis and Y-axis.

At block 312, the outputting module compares the distance data (that is, the distance from each point on the workpiece to the X-axis and Y-axis) with the predetermined tolerance range and obtains compared results. In this embodiment, when the distance from the point on the workpiece to the X-axis and Y-axis is in the predetermined tolerance range, a green label “OK” can be displayed on the interface module. When the distance from the point on the workpiece to the X-axis and Y-axis is out of the predetermined tolerance range, a red label “NG” can be displayed on the interface module.

At block 313, the data storing module stores all kinds of data produced in the process of measurement, for example, the predetermined tolerance range, the distance data, and the compared results.

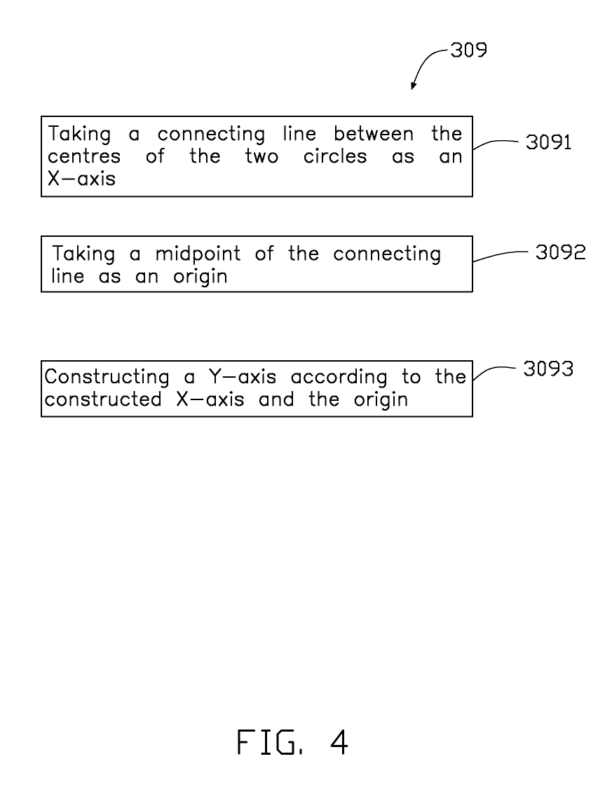

FIG. 4 illustrates a detailed description of block 309. Depending on the embodiment, additional blocks can be added, others removed, and the ordering of the blocks can be changed.

At block 3091, the coordinate system takes a connecting line between the centers of the two circles as an X-axis.

At block 3092, the coordinate system takes a midpoint of the connecting line as an origin.

At block 3093, the coordinate system constructs a Y-axis according to the constructed X-axis and the origin.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An image measuring system for measuring a size of a workpiece, the image measuring system comprising:
an interface module configured to display an image of the workpiece;
an automatic measuring module electronically connected to the interface module; and
an outputting module electronically connected to the automatic measuring module;
wherein the automatic measuring module finds features on the image of the workpiece, constructs a coordinate system according to the searched features, and measures a distance from each point on the workpiece to the constructed coordinate system, and the outputting module compares the distance with a predetermined tolerance range and outputs the distance and a compared result to the interface module.

2. The image measuring system of claim 1, wherein the automatic measuring module comprises a feature searching module, a coordinate system constructing module, and a measuring module, the feature searching module is configured to find features on the image of the workpiece, the coordinate system constructing module constructs the coordinate system according to the searched features, and the measuring module converts a position of each point on the workpiece to a coordinate value of the constructed coordinate system and measures the distance from each point on the workpiece to the coordinate system.

3. The image measuring system of claim 2, wherein the feature is a circle, the coordinate system takes a connecting line between centers of two circles as an X-axis, takes a midpoint of the connecting line as an origin, and constructs a Y-axis according to the constructed X-axis and the origin.

4. The image measuring system of claim 1, further comprising a data storing module, wherein the data storing module is electronically connected to the outputting module and stores the predetermined tolerance range, the distance, and the compared result.

5. The image measuring system of claim 1, further comprising a correction module, wherein the correction module is electronically connected to the interface module and a charge coupled device (CCD), the CCD is configured to capture the image of the workpiece, the correction module cooperates with the interface module to rectify a precision of the CCD.

6. A terminal device electronically connected to an image measuring machine for measuring a size of a workpiece, the terminal device comprising:
an image acquiring module for receiving an image of the workpiece captured by the image measuring machine; and
an image measuring system comprising:
an interface module configured to display the image of the workpiece;
an automatic measuring module electronically connected to the interface module; and
an outputting module electronically connected to the automatic measuring module;
wherein the automatic measuring module finds features on the image of the workpiece, constructs a coordinate system according to the searched features, and measures a distance from each point on the workpiece to the constructed coordinate system, and the outputting module compares the distance with a predetermined tolerance range and outputs the distance and a compared result to the interface module.

7. The terminal device of claim 6, wherein the automatic measuring module comprises a feature searching module, a coordinate system constructing module, and a measuring module, the feature searching module is configured to find features on the image of the workpiece, the coordinate system constructing module constructs the coordinate system according to the searched features, and the measuring module converts a position of each point on the workpiece to a coordinate value of the constructed coordinate system and measures the distance from each point on the workpiece to the coordinate system.

8. The terminal device of claim 7, wherein the feature is a circle, the coordinate system takes a connecting line between centers of two circles as an X-axis, takes a midpoint of the connecting line as an origin, and constructs a Y-axis according to the constructed X-axis and the origin.

9. The terminal device of claim 6, wherein the image measuring system further comprises a data storing module, the data storing module is electronically connected to the outputting module and stores the predetermined tolerance range, the distance, and the compared result.

10. The terminal device of claim 6, wherein the image measuring system further comprises a correction module, the correction module is electronically connected to the interface module and a charge coupled device (CCD), the CCD is configured to capture the image of the workpiece, the correction module cooperates with the interface module to rectify a precision of the CCD.

11. A method of inspection of a workpiece comprising:
capturing one or more images of a workpiece placed on a platform;
identifying one or more pre-determined points on the one or more images of the workpiece;
constructing a coordinate system based on the one or more pre-determined points;
measuring, within the constructed coordinate system, a distance from the one or more pre-determined points to a set of points on the surface of the workpiece;
comparing the measured distance for each point of the set of points to a pre-set value;
obtaining compared results by determining whether a difference between the measured distance and the pre-set value for each of the set of points is within a predetermined tolerance range;
storing the measured distance for each point of the set of points and the compared results; and
outputting the compared results.

12. The method of claim 11, wherein the step of constructing the coordinate system comprising:
taking a connecting line between centers of two circles as an X-axis;
taking a midpoint of the connecting line as an origin; and
constructing a Y-axis according to the constructed X-axis and the origin.

13. The method of claim 11, further comprising converting a position of each point of the set of points on the workpiece to a coordinate value of the constructed coordinate system.
